(19) United States
(12) Patent Application Publication
(10) Pub. No.: US 2006/0082816 A1
(43) Pub. Date: Apr. 20, 2006

(54) Printer device and related method for handling print-and-hold jobs

(75) Inventors: Stuart W. Daniel, Lexington, KY (US); Shaun T. Love, Lexington, KY (US); Steven F. Weed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 10/966,689

(22) Filed: Oct. 15, 2004

(51) Int. Cl. G06F 3/12

(52) U.S. Cl. 358/1.15

(57) ABSTRACT

A printer device receives and stores print-and-hold jobs. If a received print-and-hold job is a peer job, the printer device generates job data for communication to one or more peer printer devices. The printer device may include a print preview function and may provide a user with the ability to print a previewed document at a remote printer device.

### TECHNICAL FIELD

The present invention relates generally to printer devices, and more particularly, to a printer device and related method particularly suited for print-and-hold jobs.

### BACKGROUND OF THE INVENTION

In the current business environment there exists an increasing need to share information and distribute documents electronically. Utilizing computer to computer transfer or multi-user access to certain documents provides such capabilities. By providing more advanced printer device functions, information sharing and document distribution can be enhanced.

### SUMMARY OF THE INVENTION

In one aspect, a printer device includes a controller, a user interface associated with the controller and at least one communication port associated with the controller for enabling communication with one or more external devices. The controller is operable upon receipt of a print-and-hold job to: (i) store the print-and-hold job, and (ii) determine if the print-and-hold job is a peer job and, if so, to automatically send job data to the communication port for communicating the job data to at least one peer printer device.

In another aspect, a printer device includes a display; a print engine; and a controller for receiving and processing print-and-hold jobs, wherein the controller is connected with the display and the print engine. The controller is operable to display a list of print-and-hold jobs on the display; preview, on the display, a given job of the list when selected by a user for preview; and effect printing of a given job of the list when selected by a user for print. Printing is implemented by either generating a print message for the print engine of the printer device or generating a print message for communication to another printer device via a communications port of the printer device.

In a further aspect, in a printer device system which includes a plurality of interconnected printer devices, a method comprises the following steps: (a) receiving a print-and hold-job at a given printer device of the plurality of interconnected printer devices, the print-and-hold job is stored at the given printer device and is a peer job; (b) sending job data for the print-and-hold job from the given printer device to at least one peer printer device of the plurality of interconnected printer devices; (c) responsive to user input at one of the given printer device or the peer printer device, printing the print-and-hold job at at least one printer device of the plurality of interconnected printer devices.

In yet another aspect, a method for printing and previewing a print-and-hold job in a print system which includes first and second interconnected printer devices, the method involves the steps of generating a print preview for a print-and-hold job on a display of the first printer device; and responsive to a remote print selection input via a user input component of the first printer device, the first printer device generates print command data for delivery to the second printer device.

### BRIEF DESCRIPTION OF THE DRAWINGS

FIG. 1 is a block diagram of a printer device;

FIG. 2 is a flow chart showing message processing;

FIG. 3 is a flow chart showing user interface processing;

FIG. 4 is an exemplary graphical-user-interface display; and

FIG. 5 is a block diagram of an exemplary print-and-hold job file.

### DETAILED DESCRIPTION

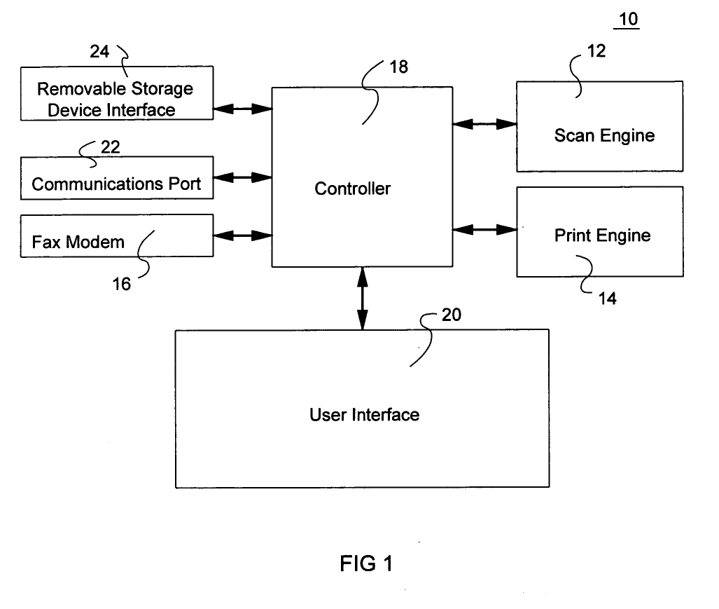

Referring to FIG. 1, a block diagram for one embodiment of a printer device 10 is shown. The illustrated printer device 10 is a multi-function device capable of performing multiple functions, such as printing, scanning, copying and faxing functions. Printer device 10 includes a scan engine 12, a print engine 14 and fax modem 16 connected with a controller 18. In an alternative embodiment, printer device 10 may also be a device which only performs a print function. A user interface 20 is also connected with the controller 18, and in one implementation includes a display on which a graphical-user-interface is generated. Alternatively, the user interface 20 could be a combination of a text only display and one or more standard user input buttons. A communications port or ports 22 is also associated with the controller 18 enabling the controller 18 to receive print jobs and other data and communications from external remote devices. A removable storage interface 24 may also be associated with the controller 18, enabling the controller 18 to transfer data to or from the removable storage device 24.

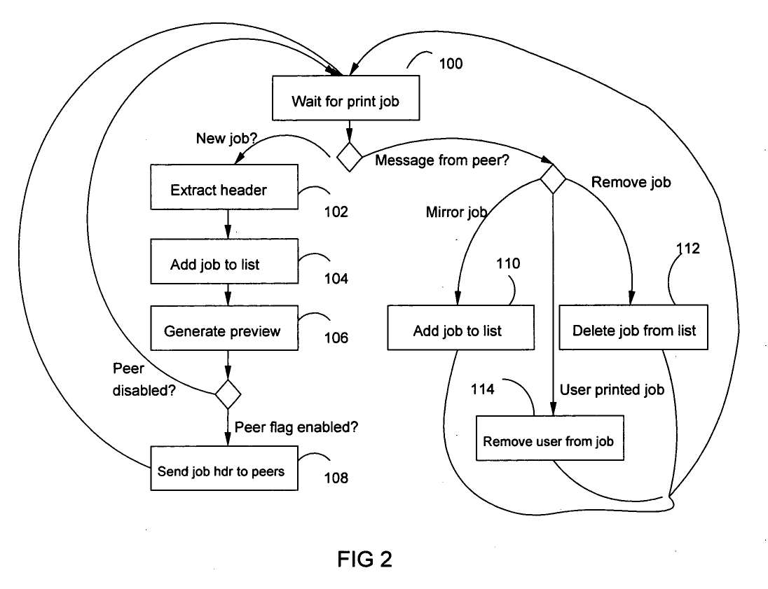

The printer device 10 is particularly suited for handling print-and-hold jobs, which by definition are print jobs that are sent to the printer device 10 and maintained at the printer device 10 for some extended period of time. This period may be established according to criteria such as (i) hold until deleted, (ii) hold until a user or users have printed, (iii) hold for a set time period or (iv) combinations of the above. Exemplary processing by the controller 18 for print message data received is reflected in the steps of the flow chart of FIG. 2. In particular, step 100 represents a message waiting state. Upon receipt of a message, if the message is a new print-and-hold job received from, for example, a computer or print server, the header for the print-and-hold job is extracted at step 102, the print-and-hold job is stored and added to a job list at step 104 and a preview of the print-and-hold job may be generated at step 106, if desired. The header may typically include job attributes but does not include print image data. Where the print-and-hold job includes associated user data, which is defined as data identifying a specific user or users entitled to access the print-and-hold job, the controller 18 may generate the job list on a user by user basis. The preview may be generated using the raster image processor contained on the controller 18 of the printer device 10.

The header of the print-and-hold job may also include a peer group identifier, where the peer group identifier is a value that is associated with one or more other printer devices known as peer printer devices. Multiple groups of peer printer devices may exist by utilizing multiple peer group identifier values, each value having one or more associated printer devices. In one implementation the printer devices associated with each peer group identifier value could be modifiable as desired by end users. Alternatively, such peer group information may be static. It is also possible that one or more printer devices could be associated with a peer group identifier value by reference to one or more other peer group identifier values. A particular value may be reserved and used as the “peer group identifier” when there is no peer group associated with the job. If the print-and-hold job is not a peer job, then after step 106 processing returns to the message wait step 100. On the other hand, if the print-and-hold job is a peer group job, after step 106 the controller 18 generates job data at step 108 for delivery to the communications port 22 so as to be sent to one or more peer printer devices. In this regard, the controller 18 may include a stored list of peer printer devices, or may access a network database via communications port 20 to identify the one or more peer printer devices. In another embodiment, broadcast messages through the communications port 22 may be used to dynamically identify printer devices that are members of the peer group. The generated job data may be only the header data, or in alternative implementation the job data may be all data for the print-and-hold job. In some embodiments, the job messages may be encrypted during transmission in order to protect confidential print job data.

Where the message received is a message from a peer printer device, the message may be the job header from a print-and-hold job sent to another printer device, in which case the controller 18 may mirror the print-and-hold job by adding the job to its job list at step 110. If the peer message is a message directing the controller 18 to delete a given job, the controller 18 deletes the given job from its job list at step 112. If the peer message is a message indicating that a particular user associated with a given print-and-hold job has printed the job, at step 114 the controller 18 updates its job data for that given print-and-hold job by removing that particular user from the job data or by changing the state of a flag to indicate that the particular user has printed the job.

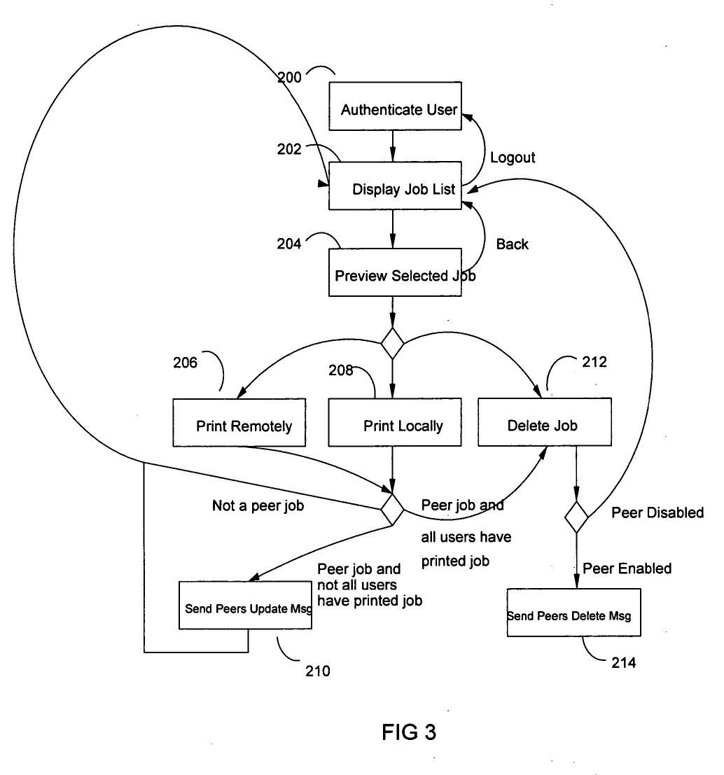

Referring now to FIG. 3, an exemplary flowchart depicting user interface processing is provided. At an initial step 200, a user is authenticated by requiring the user to enter a user-specific access code or password. Where the printer device is connected in a computer network, authentication of the user-specific access code may be effected using Lightweight Directory Access Protocol or some another authentication protocol such as Active Directory or RADIUS. At step 202 a job list for the authenticated user is displayed. If the user logs out after step 202, processing returns to step 200 to await input by another user.

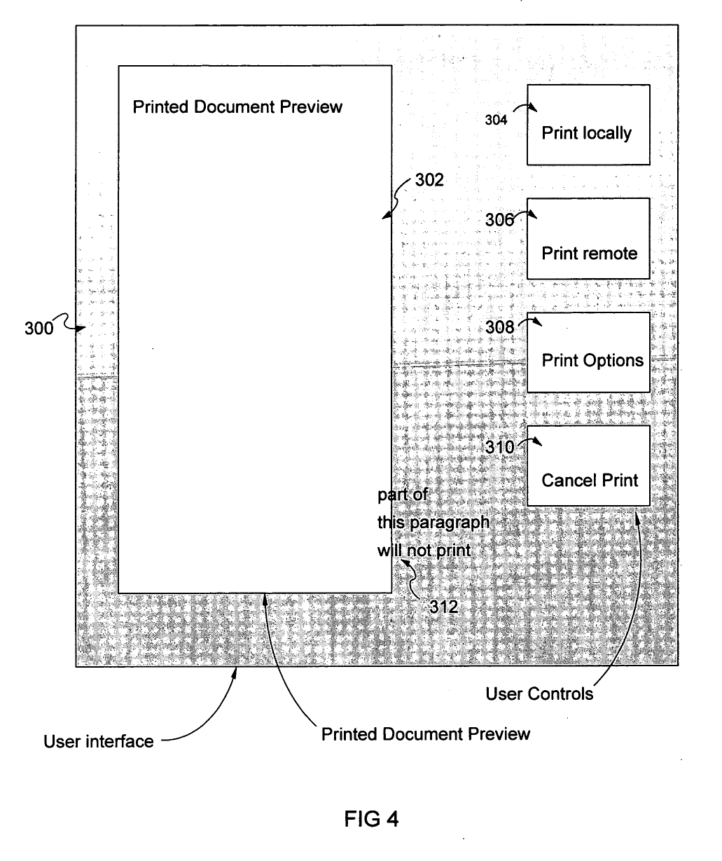

Upon selection of a given print-and-hold job of the displayed list, a preview of the selected print-and-hold job may be displayed at step 204. The preview step 204 may be the initial step of the printing process, and if the user inputs a cancel print selection, processing returns to step 202. Alternatively, the user may make an input selection to print the job remotely or locally, or to delete the job entirely. In this regard, the controller 18 is operable to permit the user to enter a print remote selection. For example, if the user selects the print remote option 306 (FIG. 4), the controller 18 may generate and effect display of a list of remote printer devices at which printing may be effected. When a remote printer device is selected, at step 206 the controller 18 generates print command data and sends that print command data to the communications port 22 for delivery to the selected remote printer device. If the remote printer device has been previously provided with only job header data, the print command data may include needed image data. Alternatively, if the remote printer has been previously provided with all job data, the print command data may exclude image data. The remote printer device may be a printer device that lacks a preview function, enabling a user to preview the job at a printer device with preview capability, and then print the job at another printer device that lacks the preview capability. If the user enters a print local selection, at step 208 the controller 18 generates print data for the local print engine 14, and the print-and-hold job is printed.

After either of steps 206 or 208, if the printed job is a peer job and not all users associated with the printed job have printed, the controller 18 generates a peer update message at step 210 to communicate to designated peer printer devices which particular user just printed the job, and processing returns to step 202. Alternatively, if the printed job is not a peer job, processing returns directly to step 202. As another alternative, if the printed job is a peer job, and all users have printed the job, the job may be deleted at step 212, and at step 214 all peer printer devices are sent a job delete message.

After previewing a selected print-and-hold job at step 204, responsive to a job delete input selection by a user, the controller deletes the selected job at step 212 and returns to processing step 202 if the deleted job is not a peer job or sends the job delete message to peer printers at step 214 if the deleted job is a peer job.

In another embodiment, there may be dynamic changes to the peer group membership. When a new printer device is turned on, it may send a message to the other members of the peer group requesting stored job information through the communications port 22. Similarly, if a printer device is required to shut down, it may notify the other members of the peer group via a message through the communications port 22. If the primary copy of the print job data for one or more stored peer jobs is stored by the printer device that is shutting down, the printer device may use a message to transfer the print job data to another peer.

In another embodiment, the printer device 10 may be operable to provide additional options to authenticated users. For example, the user may be provided the ability to view and change certain print/finishing options, such as whether the job should be (i) printed in duplex, (ii) stapled upon print or (iii) collated. An authenticated user may also be allowed to print the document on restricted media, such as blank checks or other media with embedded security features such as holograms or radio-frequency identification tags. Also, in addition to automatically deleting a job once a user or users has printed it, the printer device 10 may be configured to permit the user to enter a retain job selection, which prevents or defers the deletion of the job.

Referring to FIG. 4, an exemplary graphical-user-interface of a print preview generated for a selected job is shown and includes a display 302 of the printed document preview, as well as user control options such as print locally 304, print remote 306, print options 308 and cancel print 310. The print options 308 control may be used to view and change certain print options as mentioned above. Within print options 308, a user may also be given the opportunity to delete the job entirely without ever printing. However, it is highly desirable that only certain user(s) would be provided with this capability, such as one or more administrators designated in the job header. Upon deletion of a job, the printer device 10 might retain certain job information, such as who deletes the job or which users did or did not print the job.

FIG. 4 also illustrates another potential feature incorporated into the print preview, namely communication to the user if job data is lost. As shown, if the controller 18 determines that certain print job data is lost from the page and will not print, a visual message 312 may be displayed to advise the user of the problem. Alternatively, the preview could illustrate the lost job data by highlighting or illustrating text or image data outside the illustrated page perimeter to indicate that such data will not be printed on the page. This special preview feature may be effective at all times or may be a special mode that can be activated by a user. In yet other alternative embodiments, an audible signal or message may be played to advise the user of the problem.

Print-and-hold jobs may also be created from print data stored on the removable storage device 24. The user may operate the user interface 20 to identify print data stored on the removable storage device 24. Once the print data has been identified, the controller 18 may create a new print-and-hold job by sending an appropriate message header and the selected print data to the state machine shown in FIG. 2. In this method, the controller 18 and user interface 20 effectively replace the host computer. A user may walk up to any printer device in the peer group and create an electronic document for one or more users to print later. The user interface 20 may also be operated to select a mechanism for reporting the job completion. For example, the user might enter an email address to notify when the job has been printed.

Through the user interface 20, a user may also choose to receive an electronic copy of a print-and-hold job. In this case, the controller 18 will export an electronic copy of the print job data to the removable storage device 24. The file name and format may be selected using the user interface 20, or the controller 18 may use a predetermined or default file name and/or format. The user may also elect to send the electronic copy of the print job to a network destination, either as an attachment in an electronic mail message or directly to a server. In either case, the controller 18 may use the communications port 22 to retrieve the print job data from a remote peer printing device (if necessary), and then transmit the electronic copy through the communications port 22 to the network destination.

In effecting the various functions noted above, each print-and-hold job may incorporate any information necessary for the functions. For example, the printer device driver may attach the following information to any affected jobs as needed: (i) a User ID (UID) for the job creator (for returning status of the job when printed or removed), (ii) a Group/User list that can retrieve the job (if restricted to the creator, NULL or UID), (iii) the Job hold time, (iv) a Hold for all flags (so that a job will be held until all associated users print the job, the job time expires or it is manually removed) and (v) a Peer group flag or other identifier (when set, other printer devices in the peer group will be notified of the job).

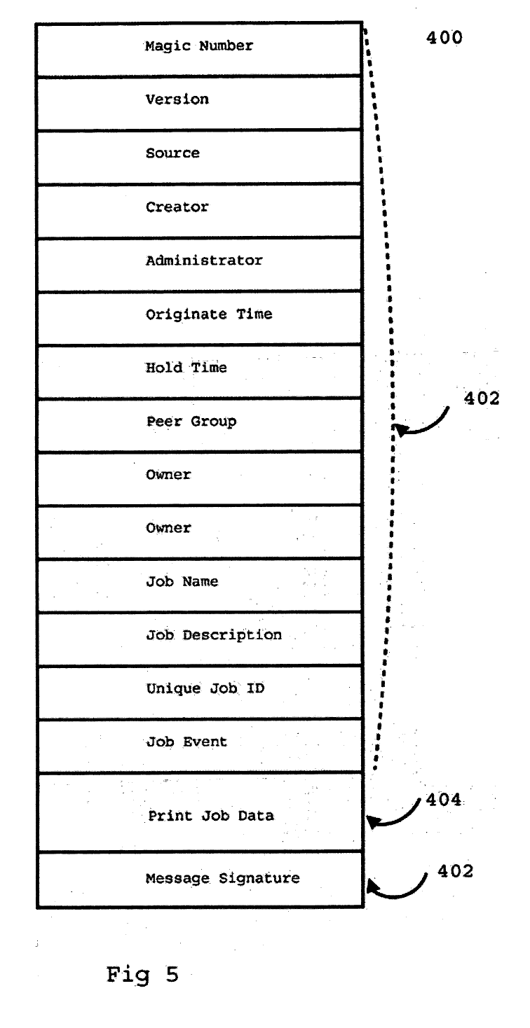

One exemplary print-and-hold job file 400 is shown in FIG. 5, with various possible header parts/fields 402 along with the print job data (image data) field 404. Fields in the header may be variable in length and contain text or binary data, according to the particular implementation. Text fields may be encoded using a variety of methods, ranging, for example, from simple ASCII characters to Unicode or UTF-8.

While implementations may vary, a syntax similar to the Printer Job Language may be employed, wherein each field is specified using a simple format of <NAME>=<value>. Rather than delineating the end of each field with a carriage return, however, each field would be prefixed with a length field specifying the number of bytes in the field. The size prefix allows a stream oriented parser to read a known number of bytes for each field. The first “=” character signifies the end of the “name” of the header field while the remaining bytes are assumed to be part of the header. Alternatively, the header may be encoded using XML.

Below are descriptions of the basic fields which may be included in the print-and-hold job header 402. Not all fields are required for each job.

The “Magic Number” field is a fixed value uniquely identifying the header as a print-and-hold job header. This field is required for all print-and-hold jobs and is preferably contained first field of the header. If the Magic Number field is missing or omitted, the job is treated as a normal print job.

The “Version” field contains the major and minor version numbers of the header format. It allows future alterations of the header format while maintaining backwards compatibility. This field is optional for print-and-hold jobs.

The “Source” field holds an ID (such as the host name) of the machine originating the print-and-hold job. It may used to send status updates from the printer device 10 such as “job finished” or “job deleted”. The “Source” field may also be displayed on the user interface to help identify the job. This field is optional for print-and-hold jobs.

The “Peer Group” field identifies the peer group of machines to which a print-and-hold job belongs. A single printer device 10 may belong to more than one peer group; for example, a printer device may be part of both the “Building 1 MFPs” and “Bldg 1/Floor 4 MFPs” groups. If this field is set to “none”, the print-and-hold job is not shared with other printer devices. This field is optional for print-and-hold jobs, and its omission may prevent the print-and-hold job from being shared or cause the print-and-hold job to be shared with a default peer group, depending on the implementation.

The “Unique Job ID” is created by the printer device 10 to uniquely identify the print-and-hold job. For example, the print-and-hold job id may be created by concatenating the device name with the current time and appending a random number. This field is not included when a host originates a print-and-hold job but is required in any peer group messages sent between the printer devices themselves.

The “Originate Time” field records when the job is created and is added by the printer device 10 to any peer group messages. It is not required for the print-and-hold job origination message.

The “Hold Time” field is created by the host that originates the print-and-hold job, and indicates the amount of time after “Originate Time” before the print-and-hold job may be removed if it is not printed. Setting this value to 0 implies the print-and-hold job should be held indefinitely. This field is required in all messages.

The “Owner” field contains the name of a user or group that may access and print the print-and-hold job. This field is required in all messages.

The “Administrator” field contains the name of the user or group that has administrative access to this print-and-hold job and can thus perform certain actions such as print-and-hold job deletion, extending the hold time, or altering the list of users with access to the print-and-hold job. If it is omitted, the Owner field may be used to perform administrative actions.

The “Creator” field contains the name of the user that created the print-and-hold job and may be displayed on the user interface 20 as part of the print-and-hold job information. If it is omitted, the Owner field may be used to indicate the creator.

The “Job Name” field contains a short, descriptive name for the print-and-hold job that may be displayed on the user interface 20. This field is required for print-and-hold jobs.

The “Job Description” field has a longer description of the print-and-hold job that may be used when viewing job information on the user interface 20. This field is optional for print-and-hold jobs.

The “Job Event” field, which identifies the main function of the message, is required in all print-and-hold job messages. This field may specify the following events:
“create”: signals job origination (sent from the host to the printer device 10);
“mirror”: used in peer messages to pass information about a print-and-hold job from one printer device 10 to another;
“delete”: used in peer messages when deleting a print-and-hold job;
“print”: used in peer messages to remove the “owner” from a print-and-hold job;
“update”: used in peer messages when an administrator alters a print-and-hold job;
“getdata”: sent from a printer device 10 to another printer device in the peer group when a user prints a print-and-hold job that is stored at the remote peer. The remote peer may then respond with a “mirror” message containing the print data; or
   “synchronize”: sent from a printer device to another printer device in the peer group. Upon receipt of this message, the peer printer device may then respond with mirror and delete messages to update the job list at the first printer device.

The “Message Signature” field contains a unique value that may be used by a printer device that receives the message to verify the authenticity of the message. For example, this field might contain a digital signature for the remainder of the message that is encrypted with a private key by the sending printer device. Any printer device(s) that receive the message may then use the known public key for the sending printer device to decrypt the signature. This simultaneously verifies that the message has not been altered during transmission and that it originated with the known and trusted printer device. This field is optional for print-and-hold jobs.

The Owner and Administrator fields may be repeated within the print-and-hold job header. Each additional value adds an additional person to the list of people that have access to the print-and-hold job. Finally, not all messages may contain the print data for the print-and-hold job. However, a job origination message must contain the print data, as well as any “mirror” message sent in response to a “getdata” request.

The foregoing print-and-hold job file and header parts are exemplary only; variations are possible.

Athough the invention has been described above in detail referencing the illustrated embodiment thereof, it is recognized that various changes and modifications could be made. Various features and advantages of the invention are set forth in the following claims.

What is claimed is:

1. A printer device, comprising:
a controller,
a user interface associated with the controller, and
at least one communication port associated with the controller for enabling communication with one or more external devices,
wherein the controller is operable upon receipt of a print-and-hold job to:
(i) store the print-and-hold job, and
(ii) determine if the print-and-hold job is a peer job and, if so, to automatically send job data to the communication port for communicating the job data to at least one peer printer device.

2. The printer device of claim 1, wherein the user interface comprises a graphical-user-interface.

3. The printer device of claim 1, wherein the job data comprises header data from the print-and-hold job.

4. The printer device of claim 1, wherein when the controller receives a peer printer device print request message for the print-and-hold job and sends print command data to the communication port.

5. The printer device of claim 1, wherein the job data comprises all print-and-hold job data.

6. The printer device of claim 1, wherein controller is further operable upon receipt of the print-and-hold job to add the print-and-hold job to a job list.

7. The printer device of claim 6, wherein the user interface includes a display and the controller is operable to effect display of the job list on the display.

8. The printer device of claim 6, wherein the user interface includes at least one user input component enabling print selection of a given print-and-hold job from the job list.

9. The printer device of claim 1, wherein the user interface permits remote print selection of the given print-and-hold job, and in response to remote print selection the controller sends print command data to the communication port for communicating print data to at least one other printer device.

10. The printer device of claim 7, wherein the user interface includes at least one user input component enabling preview selection of a given print-and-hold job on the job list, and the controller responsively displays on the display a print preview of the given print-and-hold job.

11. The printer device of claim 7, wherein the controller includes a preview mode that, when active, will identify on the display if print data of the given print-and-hold job is lost.

12. The printer device of claim 1, wherein the controller is operable to require a user to enter, via the user interface, a user-specific access code in order to view a user specific job list for such user.

13. The printer device of claim 12, wherein the user interface includes at least one user input component enabling print selection of a given print-and-hold job of the user specific job list, and the controller determines whether all users associated with the given print-and-hold job have printed the given print-and-hold job.

14. The printer device of claim 13, wherein if the controller determines that all users associated with the given print-and-hold job have printed the given print-and-hold job and that the job is a peer job, the controller sends a job delete message to the communication port for communication to at least one peer printer device.

15. The printer device of claim 13, wherein if the controller determines that less than all users associated with the given print-and-hold job have printed the given print-and-hold job and that the job is a peer job, the controller sends an update message to the communication port for advising at least one peer printer device of the user that just printed the given print-and-hold job.

16. The printer device of claim 1, wherein if the controller determines that all users associated with the given print-and-hold job have printed the given print-and-hold job, the controller deletes the given print-and-hold job.

17. The printer device of claim 1, wherein the printer device is a multi-function device including a scan capability and a fax capability.

18. The printer device of claim 1, wherein the controller is operable to permit finishing options for the print-and-hold job to be viewed and modified via the user interface prior to printing.

19. The printer device of claim 1, wherein the print-and-hold job is retrieved from a removable storage device.

20. The printer device of claim 1, wherein the print-and-hold job may be exported to one of a removable storage device and network destination.

21. The printer device of claim 1, wherein the print-and-hold job is created using print data from a removable storage device.

22. A printer device, comprising:
a display;
a print engine; and
a controller for receiving and processing print-and-hold jobs, the controller connected with the display and the print engine, the controller operable to:
display a list of print-and-hold jobs on the display;
preview, on the display, a given job of the list when selected by a user for preview; and
effect printing of a given job of the list when selected by a user for print by one of generating a print message for the print engine of the printer device and generating a print message for communication to another printer device via a communications port of the printer device.

23. The printer device of claim 22, wherein the display is part of a graphical-user-interface of the printer device.

24. The printer device of claim 22, wherein the controller and the user-interface are operable together to require a user to enter a user-specific access code associated with the given job.

25. The printer device of claim 22, wherein the controller is further operable to determine if all users associated with the given job have printed the given job and, if so, to delete the given job.

26. The printer device of claim 22, wherein the controller is further operable to determine if the given job is a peer job and, if so, to generate a message for delivery to other printer devices indicating that a particular user has printed the given job.

27. The printer device of claim 22, wherein the controller is operable, upon receipt of a job delete message for a particular job from another printer device, to delete the particular job and no longer effect display of the particular job on the print-and-hold job list.

28. The printer device of claim 22, wherein the controller includes a preview mode that, when operable, will identify on the display if print data of the print-and-hold job is lost.

29. The printer device of claim 22, wherein the controller is operable to permit finishing options for the print-and-hold job to be viewed and modified via the user interface prior to printing.

30. In a printer device system including a plurality of interconnected printer devices, a method comprising the steps of:
receiving a print-and hold job at a given printer device of the plurality of interconnected printer devices;
sending job data for the print-and-hold job from the given printer device to at least one peer printer device of the plurality of interconnected printer devices; and
responsive to user input at one of the given printer device and the peer printer device, printing the print-and-hold job at at least one printer device of the plurality of interconnected printer devices.

31. The method of claim 30, wherein the print-and-hold job is printed at a printer device other than the given printer device or peer printer device.

32. The method of claim 30, wherein the print-and-hold job is printed at the given printer device and at the peer printer device.

33. The method of claim 30, wherein the print-and-hold job identifies a plurality of users having access thereto and the given printer device maintains the print-and-hold job until all users have accessed and printed the print-and-hold job.

34. The method of claim 30, wherein after all users have accessed and printed the print-and-hold job, the given printer device deletes the print-and-hold job.

35. The method of claim 30, wherein after all users have accessed and printed the print-and-hold job, a message is sent from the given printer device to the peer printer device directing the peer printer device to delete job data for the print-and-hold job.

36. The method of claim 30, wherein the given printer device is operable to permit preview of the print-and-hold job.

37. The method of claim 30, wherein the given printer device produces a print preview for the print-and-hold job that identifies if print data of the print-and-hold job is lost.

38. The method of claim 30, wherein less than all data for the print-and-hold job is sent to the peer printer device.

39. The method of claim 30, wherein finishing options for the print-and-hold job are modified responsive to user input at one of the given printer device and the peer printer device.

40. A method for printing and previewing a print-and-hold job in a print system including first and second interconnected printer devices, the method comprising the steps of:
generating a print preview for a print-and-hold job on a display of a first printer device; and
responsive to a remote print selection input via a user input component of the first printer device, the first printer device generates print command data for delivery to the second printer device.

41. The method of claim 40, further comprising the first printer device receiving a user-specific access code input via the user input component of the first printer device.

42. The method of claim 41, wherein the first printer device is connected in a computer network and the user-specific access code is authorized using a server over the network.

43. The method of claim 41, wherein the user-specific access code is authorized using an authentication protocol.

44. The method of claim 40, wherein said print preview identifies the print-and-hold job on the display of the first printer device if print data of the print-and-hold job is lost.

45. The method of claim 44, wherein said print preview includes notification that print data of the print-and-hold job is lost.

46. The method of claim 40, wherein the user input component is a graphical-user-interface utilizing the display.

47. The method of claim 40, wherein the first printer device is a printer device that normally stores all job data for the print-and-hold job.

48. The method of claim 40, wherein the first printer device is a printer device that stores only job header data for the print-and-hold job.

49. The method of claim 40, wherein the second printer device lacks a print preview capability.

50. The method of claim 40, further comprising the first printer device receiving print job data from another printer device.
